(19) United States
(12) Patent Application Publication
(10) Pub. No.: US 2019/0130788 A1
(43) Pub. Date: May 2, 2019

(54) Virtual Reality Microsimulation Platform

(71) Applicant: Aquinas Learning, Inc., Stamford, CT (US)

(72) Inventor: Hugh Seaton, Stamford, CT (US)

(21) Appl. No.: 16/171,643

(22) Filed: Oct. 26, 2018

Related U.S. Application Data
(60) Provisional application No. 62/577,365, filed on Oct. 26, 2017.

(51) Int. Cl. G09B 19/04; G09B 5/06; G09B 9/00; G06T 19/00; G02B 27/01; G06F 3/0346; G06F 3/01

(52) U.S. Cl. CPC G09B 19/04; G09B 5/065; G09B 9/00; G06F 3/014; G02B 27/017; G06F 3/0346; G06T 19/006

(57) ABSTRACT

An immersive audiovisual training system includes: a trainer platform computer generating a training program; a content management computer receiving the training program and using the program to retrieve educational content, background content, and challenges content; and a viewing device receiving all three contents to display a simulated environment. The background content contains information on a visual background to display in the simulated environment, and the challenges content contains data concerning one or more challenges to present to a user of the viewing device, the challenges being configured to test a professional skill of the user. The viewing device has: a processor processing the background content and challenges content to generate the simulated environment and the educational content to generate an enrichment module, which provides tips about the professional skill to the user; and a display unit displaying the simulated environment and enrichment module to the user.

### TECHNICAL FIELD

The present disclosure relates generally to an immersive audiovisual training system, and more particularly to an immersive audiovisual training system that can generate a training or practice session implemented in virtual reality, augmented reality, and/or mixed reality (e.g., augmented virtuality) for deliberate practice of a skill by the user.

### BACKGROUND

Employee training and practice are critical components in almost every company's success. Public speaking, for example, is one skill that most, if not all, employees must have proficiency. Public speaking encompasses several sub-skills, each of which comprise further sub-skills requiring effective training and practice. To be a proficient public speaker, a person needs practice in self-monitoring, eye contact, breath control, and pacing. Self-monitoring calls for specialized training with respect to tools for awareness and tools for managing. Eye contact may entail practice in identifying and prioritizing who in the audience to focus on, as well as managing how much time to spend on each audience member. Breath control requires practice in diaphragmatic breathing, which helps to slow the speaker's heart rate, calm the speaker physically, create the sound of authority and confidence, and aids in the speaker's stance and appearance. Another sub-skill of breath control may include rhythm. As for pacing, this sub-skill involves training in taking pauses and regulating speed of speech (e.g., slow, steady speed). The above listing of skills exemplify how constant training and practice thereof is important for all employees, especially those employees in manager level or leadership roles.

Lack of training and practice in employees can bring about adverse outcomes for a company, such as a failed sales pitch, a failed contract negotiation, or failure to launch a program/product due to poor public speaking skills. Thus, there is an endless effort to improve or expand the skillset of employees so that they can better perform the tasks required of them at work. Training with a coach or expert can be quite expensive and extend for a long period of time. As a result, recorded videos are often used for professional training. According to the Association of Talent Development, about half of training is delivered in person, which means the other half is delivered electronically.

Major challenges in providing effective training and practice, particularly with electronic-based training (e.g., videos), include keeping the trainee engaged and minimizing distractions. Conventional electronic-based training systems and methods also fail to immerse the user-trainee in a practice session featuring realistic scenarios (e.g., environments, conditions, challenges, equipment, etc.). That is, conventional systems do not provide realistic scenarios for a trainee to practice the skill(s) that he or she is learning or has developed. For example, in the context of public speaking skills, the trainee may need practice in speaking in an auditorium before an audience of 100 or more people, or conversely in a small boardroom before 2-3 corporate executives. In addition, the trainee may need practice speaking with certain conditions and challenges. Such conditions and challenges may include questions from an audience member, uninterested attendees, distractions from a ringing mobile phone or tapping pen, interruptions from a person entering the room, or equipment failure (e.g., laptop loses power; PowerPoint presentation is lost or corrupted).

Another drawback with conventional electronic-based training systems is that they lack real-time or immediate feedback mechanisms as the user-trainee practices the intended skill. As an example, training systems do not provide an image view of the trainee from the vantage point of the audience, nor do they monitor the vital signs, biological characteristics, body language, and/or facial expressions of the trainee during practice.

Thus, there exists a need in the art for an improved training system which has the capacity to address the above problems.

### SUMMARY

The needs set forth herein as well as further and other needs and advantages are addressed by the present embodiments, which illustrate solutions and advantages described below.

It is an object of the present teachings to remedy the above drawbacks and issues associated with conventional training systems and methods.

It is another object of the present teachings to provide a system designed for executive training, management training, leadership training, compliance training, retraining, workforce re-entry, and unemployment services. The system according to the present teachings may also be utilized in training or educating children or students.

It is a further object of the present teachings to provide an immersive system which transmits training microsimulations to a trainee via a mobile device (e.g., smart phone), a desktop computer, a laptop and/or tablet computer, a tethered headset or head-mounted display, a wireless headset or head-mounted display, a pair of virtual reality (VR), augmented reality (AR), augmented virtuality (AV), or mixed reality (MR) glasses, a pair of contact lenses, or a projection based display environment.

It is another object of the present teaching to provide an immersive training system which transmits and displays short training segments/sessions which are focused on specific subskills done over and over again, and is configured to provide real-time (e.g., immediate) and/or on-going feedback of the user's (trainee's) skill development. For example, the present teachings provide for a system which generates VR, AR, AV and/or MR experiences that deliver 2-15 minute, and preferably 4-6 minute, training sessions for deliberate practice of a particular skill. Such a system is beneficial in that it administers an intensive series of training events to the training for developing and refining professional capabilities and skills of the trainee.

It is another object of the present teachings to provide an immersive training system which generates an unlimited number of unique training experiences tailored to the needs and requirements of the trainee and/or trainer. The immersive system according to the present teachings is configurable to customize each training/practice experience with the trainer's and/or trainee's scenarios and backgrounds (VR, AR, or AV environments).

These and other objects of the present teachings are achieved by providing an immersive audiovisual training system having: a trainer platform computer that generates a training program; a content management computer that receives the training program from the trainer platform computer over a first network, the content management computer retrieving educational content, background content, and challenges content based on the training program; and a viewing device that receives the background content, the challenges content, and the educational content over a second network to display a simulated environment. The background content contains information on a visual background to display in the simulated environment. The challenges content contains data concerning one or more challenges to present to a user of the viewing device, wherein said one or more challenges are configured to test a professional skill of the user. The viewing device has a processor and a display unit. The processor processes the background content and the challenges content to generate the simulated environment. The processor also processes the educational content to generate an enrichment module, wherein the enrichment module comprises a list of notes on the professional skill. The display unit displays the simulated environment and presents the enrichment module within the simulated environment. The enrichment module may provide text and/or image(s) that present tips or information about the steps and process for building, developing, practicing, and perfecting the professional skill. In some embodiments, the enrichment module may provide text, images, and/or graphical indicators (e.g., warning lights) as a reminder to the user about what to do and what not to do while performing the professional skill. The enrichment module may also come in the form of an intelligent user interface, such as an interactive animated assistant or digital assistant (like Clippit in Microsoft Office). The animated assistant may be incorporated into a virtual environment, overlaid in a real world environment, or integrated into a real world environment. During a training session, the animated character may speak to the user to relay relevant skill information to the user, and the user in turn can interact with the animated character to obtain further information or details regarding the skill or sub-skills. In a VR configuration, the processor displays the enrichment module as a virtual object within the simulated environment. In an AR configuration, the processor displays the enrichment module as a virtual object overlaid on top of an existing space (real world environment). In a mixed reality environment, the processor may anchor the enrichment module as a virtual object within the real world, such that the enrichment module is able to interact, to an extent, with what is real in the physical world. The simulated environment is adapted to immerse the user in a practice session for practicing the professional skill. Herein, the term “simulated environment” may be a virtual environment or real world environment (existing space) in which virtual objects are overlaid or anchored therein. As an example, the enrichment module may provide training content about presentation skills, including information about sub-skills involved with giving a presentation, such as self-monitoring (e.g., tools of awareness, tools of managing), eye contact (e.g., choosing who, time spent on each audience member), breath control (e.g., monitoring heart rate, monitoring rhythm), and pacing (e.g., pausing, slow and steady speed). During a session, the processor may analyze the user's action and reaction to generate and display an appropriate enrichment module to advise and tutor the user. That is, the processor provides real-time or near-real-time feedback to the user about what adjustments to make to improve his/her professional skill. In some embodiments, the processor records the user's performance during the session, analyzes the performance at the end of the session, and provides post-session diagnostic feedback to the user on how to improve the professional skill.

In one embodiment, the immersive audiovisual system is designed to train a person in public speaking and simulate an environment in which the person can practice public speaking, while providing and/or receiving feedback from instructors, supervisors, and/or colleagues. In one example, the system may generate a microsimulation which is transmitted via a viewing device (e.g., VR/AR/AV/MR glasses; smart phone) to the trainee and immerses the trainee in a virtual or augmented meeting room or board room. One or more (e.g., 3, 6, 10, 12, etc.) senior-looking attendees are seated at a table inside the board room, and the trainee is standing in front of the table. The system may be configured to load a file or document which can be displayed to the trainee through the viewing device. The file or document may comprise bullet points of training tips or reminders related to public speaking. In particular, the bullet points are displayed in the air hovering to the right of the trainee. The bullet points can appear, disappear, and re-appear based on gaze control by the trainee. As an example, the bullet points appear when the trainee directs his/her gaze off to the right (left, down, up, or a corner) and subsequently disappears when the trainee directs his/her gaze forward. Alternatively, the bullet points may be displayed to the trainee at all times throughout the practice session.

The present teachings also provide an immersive audiovisual training system, which includes: a trainer platform computer that generates a training program; a content management computer that receives the training program from the trainer platform computer over a first network, the content management computer retrieving educational content, background content, and challenges content based on the training program; and a viewing device that receives the background content, the challenges content, and the educational content over a second network to display a simulated environment. The viewing device has a virtual space generator configured to generate a virtual space for the simulated environment based on the background content and the challenges content. The background content contains information on a visual background to display in the simulated environment. The challenges content contains data concerning one or more challenges to present to a user of the viewing device, wherein said one or more challenges are configured to test a professional skill of the user. The virtual space generator also uses the educational content to provide an enrichment module within the virtual space, the enrichment module comprising any one or more of: a list of notes on the professional skill, text and/or images that convey tips or information about the professional skill, graphical indicators reminding the user about important aspects of the professional skill, and interactive animated assistant. The viewing device has a display unit to display the simulated environment and present the enrichment module within the simulated environment, wherein the simulated environment is adapted to immerse the user in a practice session for practicing the professional skill.

Other features and aspects of the invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIG. 1 is a block diagram of an immersive audiovisual training system according to the present teachings.

FIG. 2 shows an exemplary representation of a practice session displayed to a user by the immersive audiovisual training system of FIG. 1.

FIG. 3 shows the exemplary representation of a practice session of FIG. 2, annotated with features of the immersive audiovisual training system of FIG. 1.

FIG. 4 is a block diagram of an immersive audiovisual training system according to the present teachings.

FIG. 5 is a block diagram of an immersive audiovisual training system according to the present teachings.

FIG. 6 shows an exemplary representation of a practice session displayed to a user by the immersive audiovisual training system of FIG. 1.

FIG. 7 is a diagram of exemplary information in which of the immersive audiovisual training system of FIG. 1 may display in an enrichment module for an exemplary professional skill (presentation skill).

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

The present teachings have been described in language more or less specific as to structural features. It is to be understood, however, that the present teachings are not limited to the specific features shown and described, since the devices herein disclosed comprise preferred forms of putting the present teachings into effect.

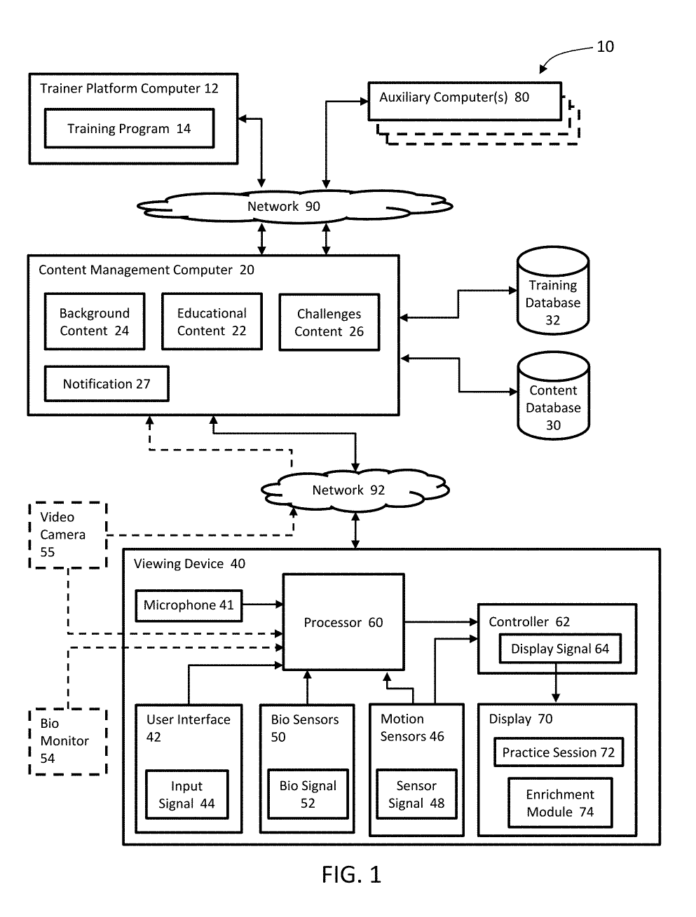

Referring to FIG. 1, an immersive audiovisual training system is shown. The training system 10 includes an authoring or trainer platform computer 12, a content management computer 20, and a viewing device 40. These three sub-systems or modules may be connected to one another via one or more communications cables, such as coaxial cables, optical fiber cables, twisted pair cables (e.g., Ethernet), or USB. In addition, or alternatively, the trainer platform computer 12, content management computer 20, and viewing device 40 may be connected to one another through wireless networks. For example, in FIG. 1, a network 90 connects the trainer platform computer 12 to the content management computer 20, while a network 92 connects the content management computer 20 to the viewing device 40. In some embodiments, the networks 90 and 92 are part of the same network, while in other embodiments, they are separate, independent networks. Although not shown, a person with ordinary skill in the art would understand that the training system 10 may include a plurality of viewing devices 40 connected to the content management computer 20 and/or a plurality of trainer platform computers 12 connected to the content management computer 20.

The trainer platform computer 12 is used to create or generate a training and/or practice program 14 for a user-trainee. By way of the training program 14, the trainer platform computer can generate or command other components of the system 10 to generate an unlimited number of unique training experiences. The practice program 14 establishes the framework and constraints for designing a practice session 72 tailored for a particular trainee. A manager or supervisor may identify in a particular employee gaps in skills, for example, related to presenting to a board, presenting to a team, negotiation, delivering feedback, or conflict resolution. By using the trainer platform computer 12, the manager can develop a training program 14 which identifies what skills and sub-skills to teach the employee (i.e., trainee), how to execute those skills and sub-skills, and what excellence looks like with respect to those skills. The training program 14 further includes information on skill practice and feedback. In particular, the training program includes information that defines the type of practice exercises to administer to the trainee. Through the trainer platform computer, the system provides the capability to customize each experience with the trainer's, or even the trainee's, scenarios and backgrounds (environments).

Once generated, the training program 14 is transmitted to the content management computer 20, which may store the training program in an internal or external storage unit. Alternatively, or in addition, the trainer platform computer 12 may save the training program 14 in a storage unit local thereto. By saving a local copy of training program, the trainer (e.g., manager) can update the program 14 at a later time based on the progress of the trainee in developing the intended skills and sub-skills, and in turn adjust the practice session 72. The content management computer 20 uses the information in the training program 14 to retrieve educational content 22 relating to the particular skills and sub-skills from a content database 30. The content database 30 may be connected to the content management computer 20 via a communications cable or wirelessly through a network. In some embodiments, the educational content 22 can be partially or totally created by the trainer at the trainer platform computer 12 and embedded within the training program 14.

With respect to the type of practice exercises to give the trainee, the content management computer 20 uses the training program 14 to retrieve background content 24 and challenges content 26 from a training database 32. The content database 30 may be connected to the content management computer 20 via a communications cable or a wireless network. Although FIG. 1 shows the content database 30 and the training database 32 are separate, one single database may store the educational content 22, the background content 24, and the challenges content 26. Still further, in some instances, there may be three databases, each storing one of the educational content 22, the background content 24, or the challenges content 26. Like the educational content, the background content and the challenges content can be partially or totally created by the trainer at the trainer platform computer 12 and embedded within the training program 14.

The educational content 22, the background content 24, and the challenges content 26 are transmitted to the viewing device 40 once they have been compiled. In some embodiments, the training program 14 may also be forwarded to the viewing device 40 from the content management computer 20. The viewing device 40 includes a processor 60 that processes the data contained in the educational content 22, the background content 24, and the challenges content 26, in order to generate a virtual reality (VR) environment where the user-trainee is immersed for purposes of learning and practicing the intended skills and sub-skills. In some embodiments, the processor 60 is configured to generate an augmented reality (AR) environment or an augmented virtuality (AV) environment in which the user-trainee can practice the intended skills and sub-skills. In still other embodiments, the viewing device 40 may comprise a combination of VR, AR, and/or AV technology, such that the training program 14 can instruct the viewing device 40 to provide of one of these types of simulations.

The viewing device 40, for example, may be any device capable of producing a VR environment, i.e., realistic images, sounds, and other stimuli that replicate a real environment or create an imaginary setting, simulating a user's physical presence in this environment. The viewing device 40 may be a virtual reality headset such as the Oculus Rift®, Samsung Gear VR®, Google Daydream View®, HTC Vive®, Sony Playstation VR®, or similar devices. The viewing device 40 may also be a portable computing device (e.g., laptop, tablet) or a smart phone, which is worn by a user via a head-mount or simply held up to a user's eyes by hand. The viewing device 40 may also be implemented via augmented reality devices such as Google Glass®, HoloLens®, Meta 2®, or other devices capable of both augmented and/or virtual reality such as contact lens displays, laser projected images onto the eye, virtual retinal displays, holographic technology, or any other devices and technologies known by those of skill in the art. When the viewing device 40 is a headset or head-mounted display, the viewing device may be connected to the content management computer 20 with a communications cable or through wireless technology (e.g., Wi-Fi, Bluetooth, radio, cellular, etc.).

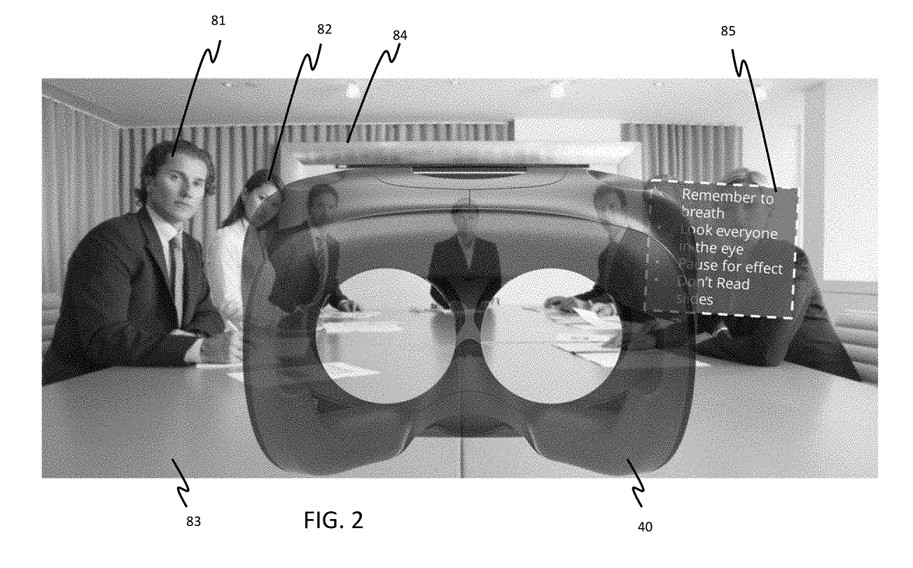

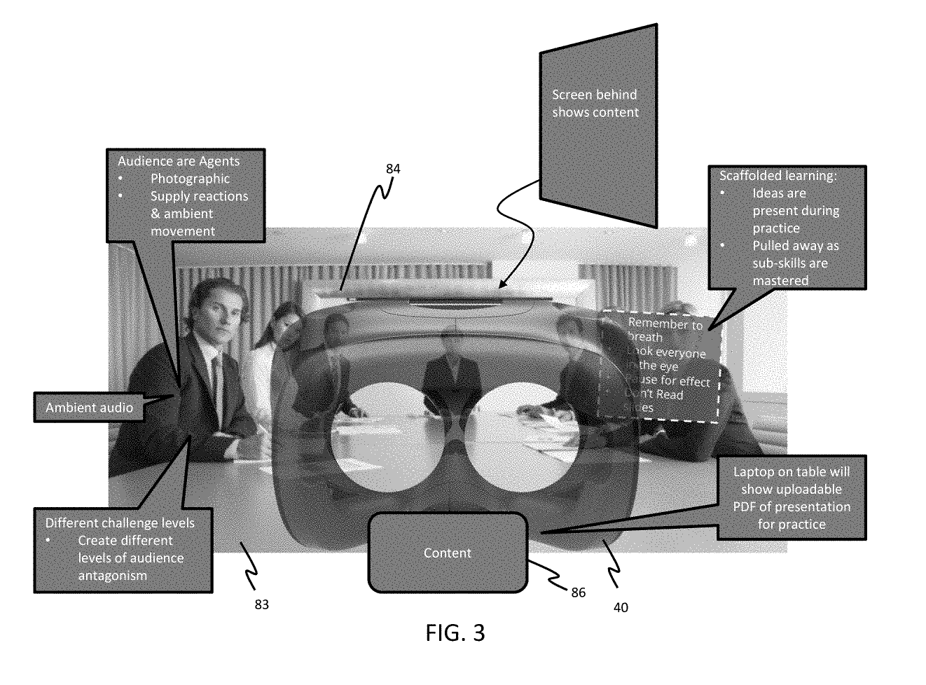

The background content 24 includes information about the particular background to display in the simulated environment for the practice session 72. For example, the background could be a cubicle or office in which the trainee will have a one-on-one interaction with a computer-simulated character or conversely an avatar, which may be controlled by the trainer (e.g., manager) from the trainer platform computer 12 or by a colleague from an auxiliary computer 80. Other examples of background content include, but are not limited to a boardroom with multiple characters and/or avatars, a classroom with a plurality of characters and/or avatars, or an auditorium with 50 or more characters and/or avatars. As shown in FIGS. 2 and 3, the background content as seen through the viewing device 40 comprises a boardroom with a conference table 83 in the center of the boardroom and a projection screen 84 situated in the back of the boardroom. The background content includes seven graphical representations of people seated at the table (i.e., audience), wherein some of them may be computer-controlled characters 81 and the remaining may be avatars 82 controlled remotely by real people from auxiliary computers 80. In some instances, the avatar 82 may be an actual or accurate depiction of the real person instead of a fictional depiction. As such, the background content 24 may include audience data, such as photographic or graphical representations of people, and further supplies reactions, ambient movement and other effects in the audience. The training system 10 may also be configured so that an avatar 82 mimics the reactions and body movements made by the real person at the auxiliary computer(s) 80. This can be accomplished with the auxiliary computer being equipped with video sensors or cameras focused on the real person, a microphone picking up speech from the real person, as well as wearable sensors. In some embodiments, the auxiliary computer 80 may include a similar viewing device 40.

The background content may further include data concerning ambient sounds. This can include, for example, speech or whispering made by the characters 81 or avatars 82, sounds of an HVAC system running, buzzing sound from lights or other electrical equipment, birds chipping outside a boardroom window, etc. The information concerning time of day (e.g., morning, evening, daylight, nighttime) and room lighting (e.g., dim ambient lighting, bright ambient lighting, spot light directed towards speaker, etc.) are also contained within the background content 24.

The challenges content 26 contains data concerning challenges to present to the trainee in the practice session 72. The challenges are meant to test the trainee's skills and expose the trainee to various obstacles so that he or she becomes experienced in handling all types of situations. In the context of public speaking, the challenges are wide ranging and can include, for example, interruptions from a ringing phone, an interruptions from a person entering the boardroom (e.g., door opens and a person asks for a moment with one of the audience members), incessant ambient noises, shuffling, or coughing, tapping pen, uninterested audience members (e.g., audience members spacing out, looking around, dozing off), questions and answers (how trainee deals with randomized questions; how trainee tactfully corrects an audience member after he or she disagrees or makes an inaccurate comment), equipment failure (e.g., laptop loses power; PowerPoint presentation is lost or corrupted), 360° image of the board/executives, opening up a laptop during a speech to show a presentation, a meeting starting with laptops open (e.g., engaging audience members), and audience members talking amongst themselves prior to start of meeting.

The challenges content 26 further defines the level of challenges to give the trainee, which may include none, easy, mild/medium, and hard/difficult. In particular, the training program 14 can set the difficulty level of challenges, wherein the content management computer 20 determines what challenges and severity thereof to retrieve from the training database 32 for configuration of the challenges content 26. For example, different levels of audience antagonism or hostility (e.g., heckling) can be defined by the challenges content 26.

The educational content 22 may include enrichment module 74 to be displayed within the simulated environment. The enrichment module may comprise lecture notes, tips on best practices for the intended skills and sub-skills, or other educational information relevant to the trainee in perfecting his or her skills and sub-skills. The enrichment module 74 helps the trainee to understand the practice session 72. Referring to FIGS. 2 and 3, as seen through the viewing device 40, the enrichment module 74 may appear as a bullet-point list 85 hovering in mid-air off to the right of the trainee. The bullet-point list 85 may appear opaque or semi-transparent. The bullet-point list may provide ideas, tips, reminders, and/or assistance during the practice session 72, especially when a challenge is presented to the trainee. The bullet-point list 85 may be configured for instructional scaffolding or scaffolded learning, so that as certain sub-skills are mastered, certain tips are removed from the list. In some embodiments, the information contained in the bullet-point list 85 may be developed by the trainer at the trainer platform computer 12 and transmitted through the content management computer 20 to the processor 60 of the viewing device 40. In addition, or alternatively, the information in the bullet-point list 85 may comprise notes or documents uploaded by the trainee into the viewing device 40.

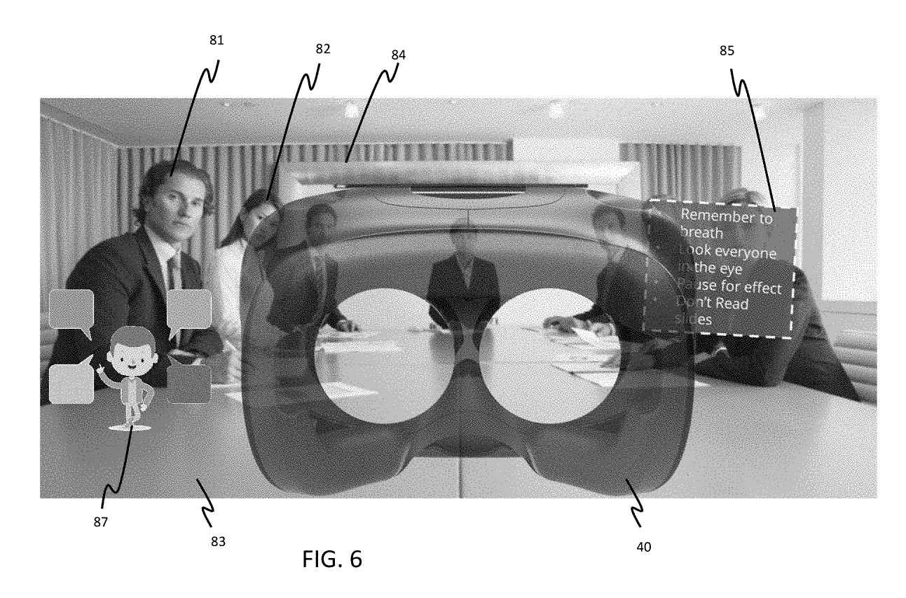

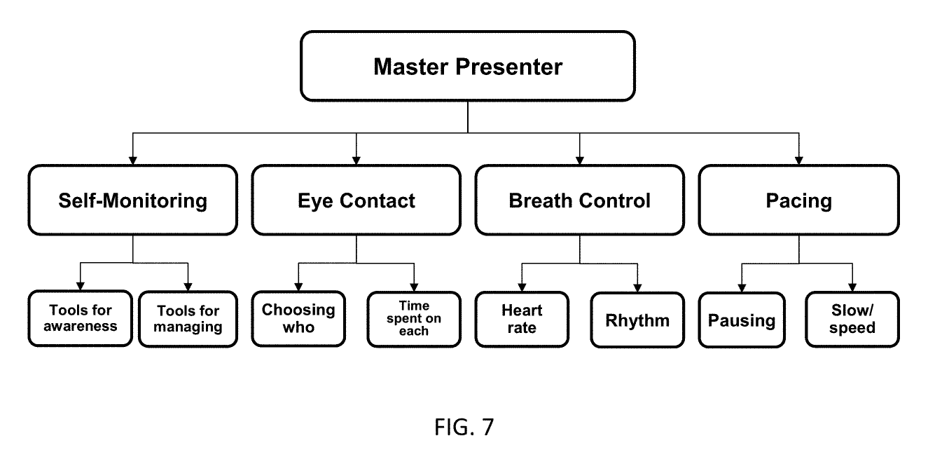

In some embodiments, the enrichment module may provide text and/or image(s) that present tips or information about the steps and process for building, developing, practicing, and perfecting the professional skill. In other embodiments, the enrichment module may provide text, images, and/or graphical indicators (e.g., warning lights) as a reminder to the user about what to do and what not to do while performing the professional skill. For example, while a user is practicing presentation skills with the system 10, the processor 60 will monitor the user's speech pace through the microphone 41, and if the pace is greater than a defined threshold (e.g., words/sec), an enrichment module in the form of a blinking light will appear to notify the user to slow his/her pace. As shown in FIG. 6, the enrichment module may also come in the form of an intelligent user interface 87, such as an interactive animated assistant or digital assistant (like Clippit in Microsoft Office). The animated assistant 87 may be incorporated into a virtual environment, overlaid in a real world environment, or integrated into a real world environment. During a training session, the animated character may speak to the user to relay relevant skill information to the user, and the user in turn can interact with the animated character to obtain further information or details regarding the skill or sub-skills. The processor 60 may be configured to pause the current training session upon receipt of user input in order for the user to interact with the animated character, or alternatively, the training session may continue or proceed as the user interacts with the animated assistant. In a VR configuration, the processor displays the enrichment module as a virtual object within the simulated environment. In an AR configuration, the processor displays the enrichment module as a virtual object overlaid on top of an existing space (real world environment). In a mixed reality environment, the processor may anchor the enrichment module as a virtual object within the real world, such that the enrichment module is able to interact, to an extent, with what is real in the physical world. As an example, shown in FIG. 7, the enrichment module may provide training content about presentation skills, including information about sub-skills involved with giving a presentation, such as self-monitoring (e.g., tools of awareness, tools of managing), eye contact (e.g., choosing who, time spent on each audience member), breath control (e.g., monitoring heart rate, monitoring rhythm), and pacing (e.g., pausing, slow and steady speed). During a session, the processor may analyze the user's action and reaction to generate and display an appropriate enrichment module to advise and tutor the user. That is, the processor provides real-time or near-real-time feedback to the user about what adjustments to make to improve his/her professional skill. In some embodiments, the processor records the user's performance during the session, analyzes the performance at the end of the session, and provides post-session diagnostic feedback to the user on how to improve the professional skill.

In some embodiments, the viewing device 40 is configured to show or remove from view the bullet-point list 85 depending on the trainee's gaze. To achieve this capability, the viewing device 40 may implement gaze control, wherein the viewing device has small image sensors (e.g., CMOS, CCD) adapted to detect the angle and position of the trainee's visual attention. When, for example, the trainee directs his or her gaze to the right, the bullet-point list 85 appears. Subsequently, when the trainee looks forward, the bullet-point list 85 disappears.

As depicted in FIG. 3, the educational content 22 may further include displaying information 86 at the bottom of the trainee's field of view. The information 86 may be embodied in the form of a laptop on the conference table 83, which shows an uploadable presentation or document (e.g., *.pdf, *.doc,*.ppt). The presentation or document may be uploaded by the trainee through the viewing device 40 or through the content management computer 20, or by the trainer via the trainer platform computer 12. The educational content 22 may also display the uploadable presentation or document on the projection screen 84. On the other hand, the educational content 22 may configure the viewing device 40 to show the projection screen 84 as displaying ideas, tips, and reminders relevant to performing the particular skills and sub-skills (FIG. 3).

Referring back to FIG. 1, the viewing device 40 has a microphone 41, which is connected to the processor 60. The microphone 41 is configured to pick up audio as the trainee speaks during the practice session 72. The processor 60 may record the audio, saving it temporarily within an internal storage unit before transmitting it the content management computer 20, the trainer platform computer 12, training database 32, and/or the auxiliary computer(s) 80.

Other components of the viewing device 40 may include a user interface 42, motion sensor(s) 46, and biometric or health monitoring sensor(s) 50. The user interface produces input signals 44 indicative of user commands received by the user interface 46. The motion sensor(s) 46 produces sensor signals 48, indicative of movement of the viewing device 40 relative to a base position. Where the viewing device 40 is a headset or head-mounted display for example, the motion sensor(s) 46 detects movement of the trainee's head, which translates into movement of the viewing device 40. The processor 60 receives the input signals 44 and the sensor signals 48, and subsequently transmits the corresponding data together with the educational content 22, the background content 24, and the challenges content 26 to a controller 62. The controller 62 controls how the VR, AR, or AV environment is created and determines how the environment is displayed to the trainee. A display signal 64 is produced by the controller 62 and sent to a display 70, wherein the practice session 72 is presented to the trainee.

The user interface 42 may comprise a microphone (i.e., microphone 41), a touchpad, buttons, and/or wired gloves. The microphone allows the trainee to control the practice session 72 using voice commands, while the touchpad/buttons would allow a user to input commands using their hands. Wired gloves provide a wider range of input using the hands, such as allowing a user to interact with a visual representation of a writing utensil shown on the display in order to write notes on a digital notepad shown on the display, or type via interaction with a visual representation of a keyboard shown on the display. Wired gloves may include haptic technology in order to enhance the trainee's ability to interact with the enrichment module 74 or the visual keyboard. The user interface 42 also provides the trainee the ability to interact with the audience, such as the computer-controlled characters 81 and remotely-controlled avatars 82, as well as other objects (e.g., laptop 86, projection screen 84) within the practice session 72. For example, the trainee may utilize the microphone to ask or answer questions from the audience during or after a presentation the trainee is giving. The wired gloves also gives the user the ability to point to a spot in the presentation displayed on the projection screen 84 or to papers lying on the conference table 83. In addition, or alternatively, the user can use the wired gloves to manipulate a visual representation of a laser pointer in order to direct the audience's attention to the presentation or papers. These features provide a realistic environment for the trainee to practice the intended skills and sub-skills (e.g., public speaking) by enhancing the immersion experience.

In some embodiments, the user interface 42 allows the trainee to pause, start, and select a point in the practice session 72. The trainee may resize or reposition the enrichment module 74 (e.g., bullet-point list 85), or interact with the enrichment module 74 so as to, e.g. look up a term in a glossary that was said in the practice session 72 but was unfamiliar to the trainee. In some embodiments, the user interface 42 provides the trainee the ability to turn on or off the enrichment module 74. In this way, the user interface 42 enhances the ability of the trainee to interact with a variety of useful aids and educational support offered through the enrichment module 74 while rehearsing or practicing a speech within the practice session 72.

One or more motion sensors 46 are included in the viewing device 40 to detect and monitor movement of the trainee and movement of the viewing device. The sensors 46 may include a gyroscope, an accelerometer, a camera, electrodes, or some combination thereof. The sensors 46 are designed to track the position and movement of the head and/or the eyes of a user wearing the viewing device 40, which can be done by detecting the change in the angular momentum using the gyroscope, the turning of the head using the accelerometer, the position and movement of the retina using the camera or the electrodes, or any other method known by those of skill in the art having the benefit of the present teachings. The sensors 46 allow the viewing device 40 to better simulate reality by adapting the view provided on the display 70 to coordinate with the movements of the trainee's head. In this way, the trainees are immersed in the simulated practice session and can seamlessly direct their attention from one audience member to another audience member, or to the projection screen 84, the laptop 86 on the conference table 83, or to another location within the room, by simply turning their head.

In some embodiments, the viewing device 40 also includes biometric or health monitoring sensors 50, which produce a biometric signal 52 representing biological feedbacks of the trainee. The sensors 50 may comprise one or more of the following: heart rate monitors, breathing monitors, and/or thermometers. The suite of sensors 50 may further include sensors or devices that monitor biosignals of the trainee, such as galvanic skin response (GSR), electrodermal activity (EDA), electroencephalography (EEG), electrocardiography (ECG/EKG), electromyography (EMG), mechanomyogram (MMG), or electrooculography (EOG). A GSR sensor for example measures the electrical characteristics of the trainee's skin. Skin conductance is affected by sweat, and sweating is an indication of psychological and physiological arousal (e.g., anger, fear, anxiety, being startled, excited, or under mental stress). The signals 52 from the sensors 50 can be used by the processor 60, content management computer 20, and/or trainer platform computer 12 to determine and monitor the level of arousal in the trainee during the practice session 72. For example, if the trainee has a rapid or irregular heart rate and increased sweating, the sensors 50 will detect these biological reactions and transmit corresponding data to the processor 40, which provides immediate feedback—such as in the form of a warning light or sound—to the trainee through the viewing device 40. Immediate feedback may also be provided to the trainer at the trainer platform computer 12, such that the trainer can evaluate the trainee's performance. In some embodiments, the biometric or health monitoring sensors 50 are integrated within the viewing device 40, connected to the viewing device via a communications cable, or wirelessly connected to the viewing device.

The data from the biometric or health monitoring sensors 50 may also be used to make real-time alterations to the practice session 72 and/or real-time adjustments to the information contained in the enrichment module 74. For example, if the sensors 50 detect biological responses indicating increased anxiety in the trainee, the processor 60 may adjust the practice session 72 so that audience antagonism is reduced or, in some cases, increased to further stress the trainee. In some situations, the processor 60 may command the controller 62 to pause or stop displaying the practice session 72 should the data from the sensors 50 indicate that the trainee can no longer manage the stress. The processor 60 may also adjust the enrichment module 74 such that the bullet-point list 85 displays a reminder to the trainee to breath slowly.

The training system 10 may also be configured to utilize data received from the microphone 41, user interface 42, bio sensors 50, motion sensors 46, bio monitoring devices 54 in order to tailor or adjust the type of educational information displayed in the enrichment module 74. For example, the bio sensors 54 may include camera(s) focused on the user's eyes. The processor 60 may use the video data from the cameras to determine whether the user is focused on a particular object in the simulated environment. If the user (practicing presentation skills) is constantly looking down at a table instead of focusing on audience members, the processor 60 will detect this and adjust the enrichment module 74 to display a note alerting the user to look at audience members. As another example, bio sensors 50 may include a heart rate monitor. If the processor detects that the user's heart rate is speeding up above a predefined threshold, it will adjust the enrichment module 74 to display a note alerting the user to take a deep breath. In the process of adjusting the enrichment module 74, the viewing device 40 sends a signal to the content management computer 20 to retrieve appropriate educational content 22 from the content database 30 and/or training database 32. The content management computer 20 will then forward the retrieved educational content to the viewing device for subsequent adjustment of the enrichment module.

Referring back to FIG. 1, the viewing device 40 may have the capacity to connect to other third-party bio monitoring devices 54, such as wireless-enabled wearable technology and fitness trackers. For example, the bio monitoring device 54 may be the Fitbit, Jawbone Up, or Lumo Lift. The training system 10 therefore can leverage the technology of the third-party bio monitoring devices 54 without increasing the complexity and size of the viewing device 40. In addition, with respect to the Lumo Lift, the training system may utilize its posture detection technology to monitor and record the trainee's posture during the practice session. For public speaking, sitting straighter and standing taller demonstrates confidence, while slouching may convey laziness.

The training system 10 is configured to provide immediate feedback and diagnostics to the trainee regarding performance of the intended skills and sub-skills as the practice session is running or after the practice session has completed. Various mechanisms may be used to achieve this immediate feedback. One example involves the processor 60 and/or the controller 62 providing a video signal to be displayed on the display unit 70, wherein the video signal shows the trainee (e.g., graphical representation thereof) from the vantage point of the audience. The processor 60 may transmit the biometric signal 52 to the controller 62 so that a graph, meter, and/or table showing the trainee's heart rate and other biometric/health data is displayed by the display unit 70 for viewing by the trainee. The viewing device 40 may include the capability for eye tracking, utilizing image sensors (the same or different from the image sensors for gaze control) to monitor and track movement of the trainee's eyes. The viewing device can also track the movement of the trainee's head using the motion sensors 46. The eye tracking and head tracking information can be helpful in determining whether the trainee is focused on the audience or looking elsewhere, and for how long the trainee spends focusing on one section of the audience versus other sections. The processor 60 may be configured to measure the talking speed of the trainee and count the number of times the trainee says “ums” and “ahs”. This speech data may be presented to the trainee through the display 70. Additionally, via the microphone 41, the processor 60 can measure voice tension as well as sound pressure level and sound intensity of the trainee's voice. This information similarly may be displayed to the trainee during or after the practice session 72. Where the user interface 42 includes the wired gloves, the processor 60 may be configured to detect and monitor the trainee's gestures and body language during the practice session. For example, the display 70 may indicate the number of times the trainee points a finger at an audience member, if the trainee has hands on the waist, whether the trainee's hands are too active (i.e., too much hand movement), and the trend in position of the trainee's hands (e.g., off to the sides, on a podium, raised in the air, etc.). As an alternative to the wired gloves, an external motion-tracking video camera 55 may be directed towards the trainee and provide a data signal to the viewing device 40. The processor 60 then processes the data signal from the video camera 55 to determine and evaluate body movement of the trainee during the practice session.

In some embodiments, the trainer platform computer 12 establishes a line of communication with the viewing device 40, through the content management computer 20 or through another network connection, so that the trainer embodies an avatar 82 and can provide real-time coaching or feedback to the trainee during the practice session. In similar respects, other people (e.g., colleagues) may use auxiliary computers 80 to virtually attend the practice session as avatars 82 and provide real-time coaching to the trainee during the practice session.

The processor 60 is configured to record video and audio of the trainee from the practice session. The viewing device 40 may be configured so that the video and audio of the practice session and all of the data collected, compiled, and generated by the processor 60, including data derived from the various sensors (e.g., motion sensors 46, biometric or health monitoring sensors 50, bio monitoring devices 54, motion-tracking video camera 55, image sensors for eye tracking, etc.), are transmitted to the content management computer 20, as well as to the trainer platform computer 12 and/or auxiliary computer(s) 80 for viewing by the trainer (e.g., manager) and other people (e.g., colleagues). In some embodiments, the video, audio and data may be compressed and packaged into an email for delivery to recipients (e.g., trainer, boss, manager, colleagues). Additionally, the video and audio of the practice session and all data collected, compiled, and generated by the processor 60 may be stored in a database, such as the content database 30, training database 32, or another database connected to the viewing device 40.

In some embodiments, the training system 10 incorporates gamification elements. The training program 14 may specify game-design elements, including points for achievement or points for team achievement. For example, the trainee will receive points for every skill or sub-skill he or she masters. In addition, each practice session may be considered a game level, and upon successful completion of a practice session, the trainee is given a score reflecting his or her performance of the intended skill or sub-skill.

Referring back to FIG. 1, the content database 30 and/or the training database 32 may be configured to store the training program 14. Any new educational content, background content, and/or challenges content that a trainer may create or upload from the trainer platform computer 12 may also be stored in one or both of the databases 30, 32. New or updated content can also be uploaded from the content management computer 20 and subsequently stored in the databases 30, 32.

The training system 10 may also be configured to send notifications to the trainee about an available practice session. The notification may come in the form of a text message, email, or pop-up window. The notification may also include a link with which to launch the practice session. In particular, the training platform computer 12 may be used to specify the format of the notification and the particular information to be included in the notification. This notification information may be stored within the training program 14 and sent to the content management computer 20. In accordance with the notification information, the content management computer 20 transmits notifications 27 to the viewing device 40 for display on the display unit 70 (or to another communications device, such as a mobile phone). For example, the content management computer 20 may send a text message to the viewing device 40 after work hours, informing the trainee to complete a practice session. In some embodiments, the content management computer 20 utilizes delivery preferences to determine when to send the notifications 27. The delivery preferences indicate when the trainee is most likely to receive the notification, and when the trainee is most likely to interact with the notification 27.

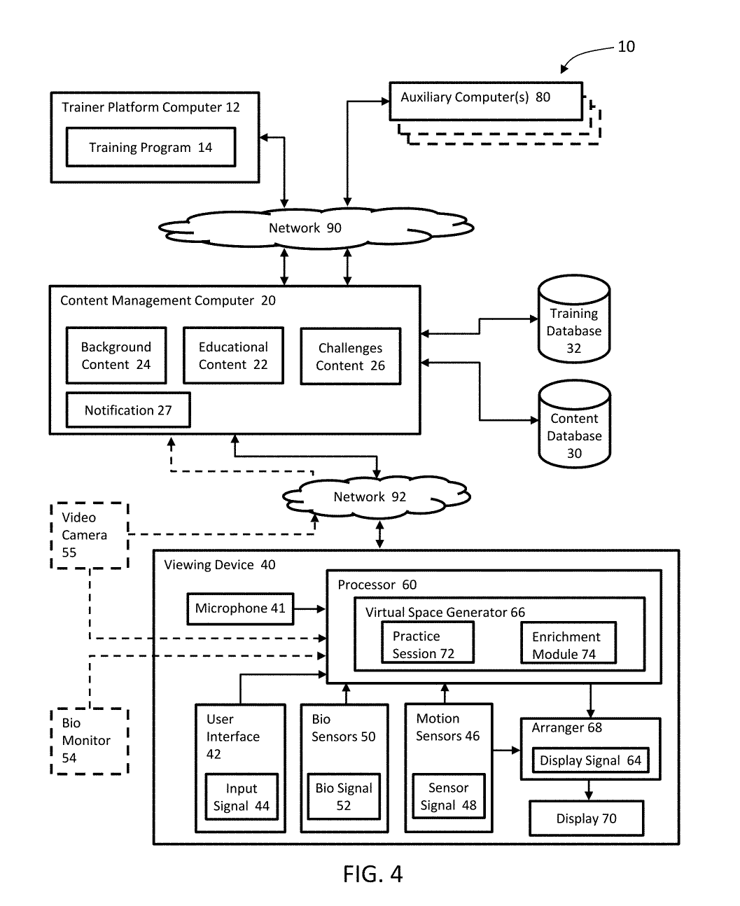

FIG. 4 shows another immersive audiovisual training system according to the present teachings. The training system in FIG. 4 is similar to the training system of FIG. 1 and has all the same characteristics and features of the training system of FIG. 1. In FIG. 4, the educational content 22, the background content 24, and the challenges content 26 are sent to a virtual space generator 66 running on the processor 60. The virtual space generator 66 receives input signals 44 from the user interface 42, sensor signals 48 from the one or more motion sensors 46, and biometric signals 52 from the biometric or health monitoring sensors 50. From these signals, the virtual space generator 66 generates a VR, AR, or AV space including the practice session 72 and the enrichment module 74. The virtual space is then transmitted to an arranger 68, which generates the display signal 64 and incorporates the data from motion sensors 46, bio sensors 50, and/or user interface 42. The display 70 receives the display signal 64 and displays a portion of the virtual space or the entire virtual space.

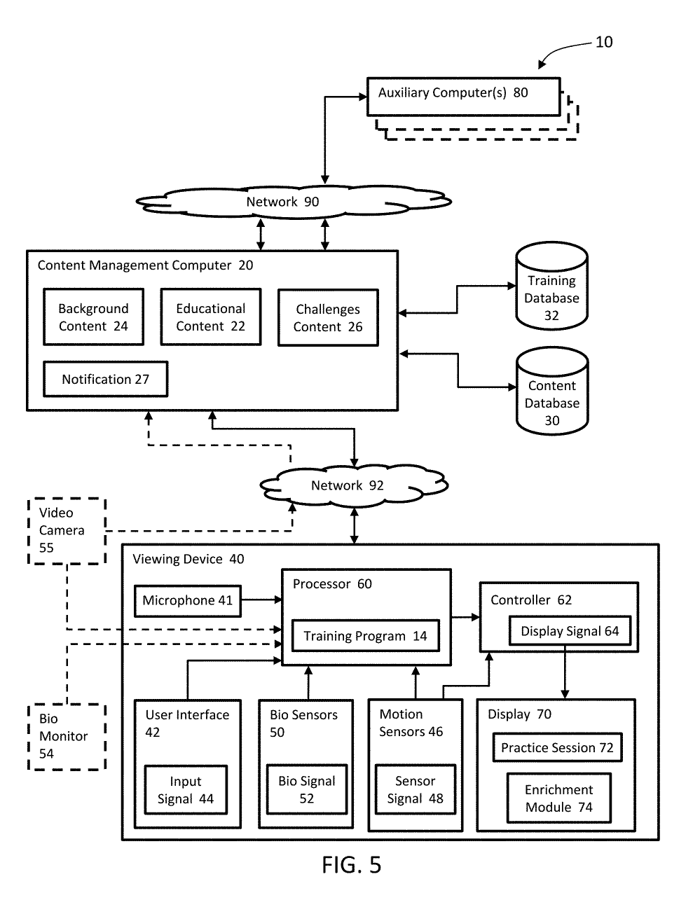

FIG. 5 shows another immersive audiovisual training system according to the present teachings. The training system in FIG. 5 is similar to the training system of FIG. 1 and has all the same characteristics and features of the training system of FIG. 1. However, in contrast to FIG. 1, the viewing device 40 in the training system of FIG. 5 may be used to create or generate a training and/or practice program 14. That is, the trainee can use the user interface 42 to create practice sessions without need of a trainer platform computer. The practice program 14 is transmitted over the network 92 so that the content management computer 20 may retrieve educational content 22, background content 24, and challenges content 26 from the content database 30 and the training database 32. The content management computer 20 then transmits the content to the processor 60 to generate the VR, AR, or AV space including the practice session 72 and the enrichment module 74.

It should be understood to a person of ordinary skill in the art that the immersive audiovisual training system according to the present teachings is applicable for training and practicing skills and sub-skills other than those related to public speaking, which is discussed herein as an example.

It should also be understood to a person of ordinary skill in the art that different configurations of the immersive audiovisual training system are possible. For example, the particular components included in the system and/or arrangement of components in the system may differ from that shown in the Figures without departing from the scope and spirit of the present teachings.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of the appended claims and their legal equivalents, as understood by those of skill in the art relying upon the disclosure in this specification and the attached drawings.

What is claimed is:

1. An immersive audiovisual training system, comprising:
a trainer platform computer generating a training program;
a content management computer receiving the training program from the trainer platform computer over a first network, the content management computer retrieving educational content, background content, and challenges content based on the training program; and
a viewing device receiving the background content, the challenges content, and the educational content over a second network to display a simulated environment, the background content containing information on a visual background to display in the simulated environment, the challenges content containing data concerning one or more challenges to present to a user of the viewing device, said one or more challenges being configured to test a professional skill of the user;
the viewing device having:
a processor to process the background content and the challenges content for generating the simulated environment, the processor processing the educational content to generate an enrichment module, the enrichment module comprising a list of notes on the professional skill; and
a display unit displaying the simulated environment and presenting the enrichment module within the simulated environment;
wherein the simulated environment is adapted to immerse the user in a practice session for practicing the professional skill.

2. The immersive audiovisual training system of claim 1, wherein the simulated environment is one of: a virtual reality environment, an augmented reality environment, a mixed reality environment, or an augmented virtuality environment.

3. The immersive audiovisual training system of claim 1, wherein the educational content is stored in a content database that is communicatively connected to the content management computer.

4. The immersive audiovisual training system of claim 1, wherein at least one of the background content or the challenges content is stored on a training database, said training database is communicatively connected to the content management computer.

5. The immersive audiovisual training system of claim 1, wherein the viewing device is a headset or head-mounted display.

6. The immersive audiovisual training system of claim 1, wherein the viewing device further includes a controller configured to determine how the simulated environment is displayed to the user, the controller producing a display signal to the display unit.

7. The immersive audiovisual training system of claim 6, wherein the viewing device further includes:
one or more motion sensors configured to detect movement of the viewing device relative to a base position, the one or more sensors transmitting a motion signal to at least one of the processor or the controller to control how the simulated environment is displayed to the user.

8. The immersive audiovisual training system of claim 7, wherein the one or more motion sensors comprises an accelerometer.

9. The immersive audiovisual training system of claim 7, wherein the one or more motion sensors comprises a gyroscope.

10. The immersive audiovisual training system of claim 1, wherein the viewing device further includes:
a user interface configured to receive commands from the user, the user interface transmitting an input signal to the processor, the input signal indicative of user interaction with the simulated environment, the processor adjusting the simulated environment according to the input signal.

11. The immersive audiovisual training system of claim 10, wherein the user interface includes a microphone.

12. The immersive audiovisual training system of claim 10, wherein the user interface includes a touchpad to control the practice session and interact with the enrichment module and objects within the simulated environment.

13. The immersive audiovisual training system of claim 10, wherein the user interface comprises an image sensor focused on at least one eye of the user, the image sensor being configured to track movement of the at least one eye and transmit an image signal, and the processor using the image signal to provide gaze control to interact with the enrichment module.

14. The immersive audiovisual training system of claim 10, wherein the user interface includes a wired glove configured to detect hand movements of the user and interpret the hand movements as said commands from the user.

15. The immersive audiovisual training system of claim 1, wherein the viewing device further includes at least one biometric or health monitoring sensor, the at least one biometric or health monitoring sensor detecting biological responses of the user during the practice session.

16. The immersive audiovisual training system of claim 15, wherein the biometric or health monitoring sensor includes a heart rate monitor.

17. The immersive audiovisual training system of claim 15, wherein the biometric or health monitoring sensor includes a device which detects electrical and/or non-electrical biosignals of the user.

18. The immersive audiovisual training system of claim 17, wherein the device which detects galvanic skin response of the user.

19. The immersive audiovisual training system of claim 17, wherein the at least one biometric or health monitoring sensor transmits a biofeedback signal to the processor, which monitors the level of arousal of the user during the practice session.

20. The immersive audiovisual training system of claim 19, wherein the processor adjusts the simulated environment based on the level of arousal of the user.

21. The immersive audiovisual training system of claim 1, wherein the viewing device is configured to connect to a wireless-enabled wearable device, the wearable device monitoring a heart rate of the user and transmitting a signal to the processor for recording.

22. The immersive audiovisual training system of claim 1, wherein the viewing device is configured to connect to a wireless-enabled wearable device, the wearable device monitoring a posture of the user and transmitting a signal to the processor for recording.

23. An immersive audiovisual training system, comprising:
a trainer platform computer generating a training program;
a content management computer receiving the training program from the trainer platform computer over a first network, the content management computer retrieving educational content, background content, and challenges content based on the training program; and
a viewing device receiving the background content, the challenges content, and the educational content over a second network to display a simulated environment, the viewing device having:
a virtual space generator configured to generate a virtual space for the simulated environment based on the background content and the challenges content, the background content containing information on a visual background to display in the simulated environment, the challenges content containing data concerning one or more challenges to present to a user of the viewing device, said one or more challenges being configured to test a professional skill of the user, the virtual space generator using the educational content to provide an enrichment module within the virtual space, the enrichment module comprising a list of notes on the professional skill; and
a display unit displaying the simulated environment and presenting the enrichment module within the simulated environment;
wherein the simulated environment is adapted to immerse the user in a practice session for practicing the professional skill.

24. The immersive audiovisual training system of claim 23, wherein:
the viewing device includes one or more motion sensors and an arranger;
the one or more motion sensors being configured to detect movement of the viewing device relative to a base position;
the arranger being configured to receive a motion signal from each of the one or more motion sensors, determine how the simulated environment is displayed to the user based on the motion signal, and transmit a display signal to the display unit.

25. An immersive audiovisual training system, comprising:
a viewing device configured to generate a training program for a user to practice a professional skill; and
a content management computer receiving the training program from the viewing device over a network, the content management computer retrieving educational content, background content, and challenges content based on the training program;
the viewing device receiving the background content, the challenges content, and the educational content over the network to display a simulated environment, the background content containing information on a visual background to display in the simulated environment, the challenges content containing data concerning one or more challenges to present to a user of the viewing device, said one or more challenges being configured to test a professional skill of the user;
the viewing device having:
a processor to process the background content and the challenges content for generating the simulated environment, the processor processing the educational content to generate an enrichment module, the enrichment module comprising a list of notes on the professional skill; and
a display unit displaying the simulated environment and presenting the enrichment module within the simulated environment;
wherein the simulated environment is adapted to immerse the user in a practice session for practicing the professional skill.
